(19) United States
(12) Patent Application Publication
(10) Pub. No.: US 2004/0158799 A1
(43) Pub. Date: Aug. 12, 2004

(54) INFORMATION EXTRACTION FROM HTML DOCUMENTS BY STRUCTURAL MATCHING

(76) Inventor: Thomas M. BREUEL, Palo Alto, CA (US)

Correspondence Address: OLIFF & BERRIDGE, PLC., P.O. BOX 19928, ALEXANDRIA, VA, 22320, US

(21) Appl. No.: 10/248,681

(22) Filed: Feb. 7, 2003

(51) Int. Cl. G06F 15/00

(52) U.S. Cl. 715/513

(57) ABSTRACT

Methods and systems are provided for automatically extracting structured information from HTML formatted document sources by use of tree isomorphism, such that structural similarities between web pages presenting different content in the same format can be used to compare the underlying information data. The method compares several HTML formatted input document, such as web pages, by: parsing each of several HTML formatted input documents into a tree structure having at least one root node and a sub-tree containing information data; performing a tree isomorphism function operation on each input document tree structure to compare the tree structures; based on specified criteria, extracting at least a subset of systematic differences and/or similarities obtained from a systematic comparison of information data contained within corresponding sub-trees; and outputting extracted data in a desired target output format. The outputted information data may be variable data.

### BACKGROUND OF THE INVENTION

1. Field of Invention

The invention generally relates to methods and systems to automatically extract information from web pages. More particularly, information extraction is through use of tree isomorphism to exploit structural similarities between pages representing different content in the same format.

2. Description of Related Art

Structured information is becoming increasingly present on the Internet in HTML format. Such structured information may include, for example, stock quotes, financial data, time tables, customer records, etc. While presentation in HTML format is convenient for human readers, knowledge extraction from HTML for automated processing is considerably more difficult because HTML formatted information contains a lot of irrelevant or repetitive explanatory text in addition to data of interest.

The increasing desire for structured presentation of information on the Internet (world-wide web) can be seen in the activities surrounding the XML standard. While the XML format can express this data directly, transition to use of the XML format will take time. Thus, it will likely be a long time until information sources have been converted to XML format. Furthermore, it is likely that some information sources will continue to provide information in only HTML format for one or more reasons.

### SUMMARY OF THE INVENTION

There is a need for improved knowledge management and document information retrieval from documents formatted using HTML. In particular, there is a need for methods and systems for automatically extracting structured information from documents, such as web pages, provided in HTML format.

In various exemplary embodiments, methods and systems provide automatic extraction of information from web pages. The extracted information may be variable data or fixed data.

In various exemplary embodiments, methods and systems provide automatic extraction of structured information from HTML formatted input documents, such as those obtained from web pages, by use of structural similarities between the web pages presenting different content in the same format. The extraction is preferably performed by tree isomorphism.

In various exemplary embodiments, a method of automatic data extraction from a plurality of HTML formatted documents, includes: parsing each of several HTML formatted input documents into a tree structure having at least one root node and a sub-tree containing information data; performing an exact or approximate tree isomorphism function operation on each input document tree structure to compare the tree structures; based on specified criteria, extracting at least a subset of systematic differences and/or similarities obtained from a systematic comparison of information data contained within corresponding sub-trees; and outputting extracted data in a desired target output format.

In exemplary embodiments, the desired target output format may be a relational database, an XML document, or a two-dimensional output table containing output rows of different HTML input documents and output columns of output data extracted from the various several HTML formatted input documents (or vice versa) based upon the systematic comparison of information data contained within corresponding sub-trees. However, other representative output formats can be used, particularly if they are equivalent to at least a subset of a two-dimensional output table.

In various exemplary embodiments, the invention may separately provide automatic data extraction from a plurality of HTML formatted documents, by: parsing each of several HTML formatted input documents into a tree structure having at least one root node and a sub-tree; performing an exact or approximate tree isomorphism function operation on each tree structure to compare the tree structures; based on specified criteria, extracting at least a subset of systematic differences and/or similarities obtained from a systematic comparison of information data contained within corresponding sub-trees; and outputting extracted data in a desired target output format.

In exemplary embodiments, the tree isomorphism operation includes a recursive algorithm. However, more complex techniques could be used, such as a non-recursive iterative algorithm using a stack or queue data structure. Alternatively, a relation-style or simulated annealing style algorithm may be used for the tree isomorphism. Additionally, tree isomorphism can be implemented by encoding the trees as graphs and applying a graph isomorphism algorithm.

While the tree isomorphism is preferably exact, similar results are obtained if the isomorphism is only approximate. Moreover, it may be desirable to have a user specified level of approximation so that certain minor differences (i.e., bold, italics or different font text) will be treated as the same for systematic comparison purposes.

These and other features and advantages of this invention are described in, or apparent from, the following detailed description of various exemplary embodiments of the systems and methods according to this invention.

### BRIEF DESCRIPTION OF DRAWINGS

The invention will be described with reference to the following drawings, wherein.

FIG. 1 shows an illustrative block diagram of a system for automatic data extraction of HTML input documents according to the invention.

FIGS. 2-3 are exemplary Internet web pages containing financial data.

FIG. 4 is an exemplary spreadsheet automatically extracted from the sample web pages of FIGS. 2-3 and other additional web pages of similar structure.

FIG. 5 is an HTML table automatically extracted from the sample web pages of FIGS. 2-3 and other additional web pages of similar structure.

FIG. 6 is a first simple exemplary input web page in HTML format.

FIG. 7 is a second simple exemplary input web page in HTML format.

FIG. 8 is a simple output in spreadsheet format showing automatic computed output from the input web pages of FIGS. 6-7.

FIG. 9 shows an exemplary tree structure for the sample web page of FIG. 6.

FIG. 10 shows an exemplary tree structure for the sample web page of FIG. 7. and

FIG. 11 shows a comparison figure of the tree structures of FIGS. 9-10 in which differences are shown in highlight.

### DETAILED DESCRIPTION OF PREFERRED EMBODIMENTS

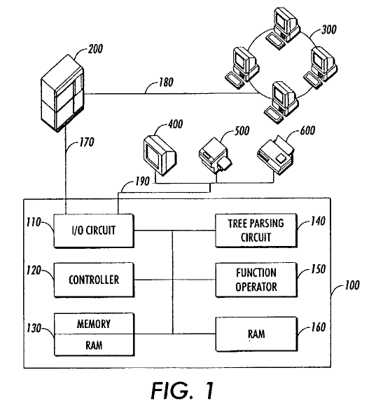

Various exemplary embodiments of the invention will be described. In a first embodiment shown in FIGS. 1-5, systems and methods of data extraction are described through which relevant data embedded within a HTML formatted document, such as a web page, are extracted by an automated process without human intervention.

An exemplary system 100 for performing automatic data extraction according to the invention will be described with respect to FIG. 1 . System 100 includes an input/output circuit 110, a controller 120, and a memory 130, which may be any appropriate combination of alterable, volatile or non-volatile memory, or non-alterable memory. The alterable memory may be any one or more of static or dynamic RAM, a floppy disk and disk drive, a write-able or rewrite-able optical disk and drive, a hard drive, flash memory or the like. The non-alterable memory can be implemented using any one or more of ROM, PROM, EPROM, EEPROM, an optical ROM disk, such as a CD-ROM or DVD-ROM disk and disk drive or the like. System 100 also includes a tree parsing circuit 140, a function operator 150, and a 2-D table generator circuit 160. A server 200 provides access to a source of HTML formatted input documents, such as a document collection or series of web pages found on Internet 300. Server 200 is connected to system 100 through a communication link 170. Similarly, server 200 is connected to Internet 300 through a communication link 180. System 100 is also connected to one or more output devices through a communication link 190.

Exemplary non-limiting examples of output devices include a monitor or display device 400, laser printer 500, ink jet printer 600 or other output device. Communication links 170, 180, 190 can be any known or later developed device or system for connecting communication devices including, for example, a direct cable connection such as a serial or parallel port cable, connection over a wide area network or local area network, a connection over an intranet, a connection over the Internet, or a connection over any other distributed processing network or system. In general, communication links 170, 180 can be any known or later developed connection system or structure used to connect devices and facilitate communication. It should be appreciated that communication links 170, 180 can be wired or wireless.

In operation, controller 120 controls the various operations of the system. Input/output circuit 110 retrieves documents or web pages containing HTML formatted content, such as by surfing the Internet 300 through server 200 or from other input source, such as a scanner, from memory 130, etc. Retrieved documents may then be stored in memory 130. During or subsequent to collection of all input documents to be retrieved, tree parsing circuit 140 build a tree structure, in which each node has a potentially arbitrary number of children, from the formatting of each input document received. The thus obtained trees are then stored in memory 130 and analyzed by function operator 150, which acts as a comparison mechanism to recursively compare the various tree structures to isolate items of interest automatically from the various HTML coded documents. Based on the comparison, 2-D table generator 160 generates a two-dimensional table of relevant information data extracted from the various HTML input documents. The extracted data may then be output to an output device, such as output devices 400, 500 and 600, for presentation to a user of the extracted information.

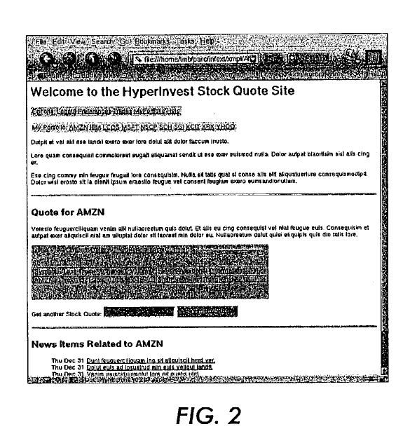

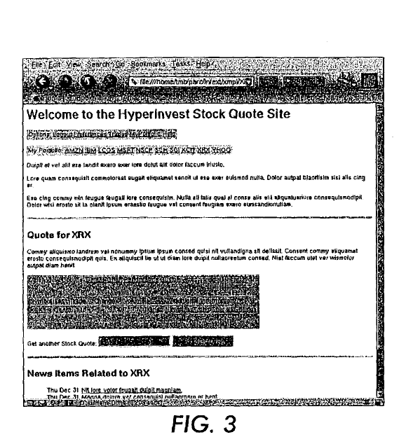

FIGS. 2-3 show examples of HTML web pages containing financial information that may be obtained from Internet 300, such as through server 200. However, the invention works on any HTML formatted input document, which may be obtained through other networked or local databases or memory location or stored or generated locally at system 100. These particular examples are fictitious, but could have come from any of the countless number of Internet resources that provide stock price quotations or any other information contained within an HTML coded document format. The web pages contain various fields containing information, such as text, numbers, graphics, images, links, or other information.

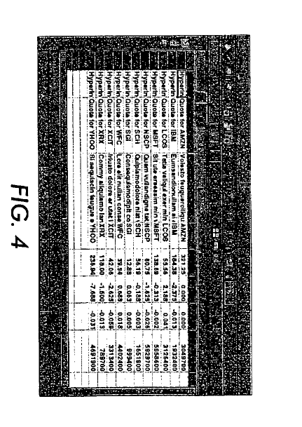

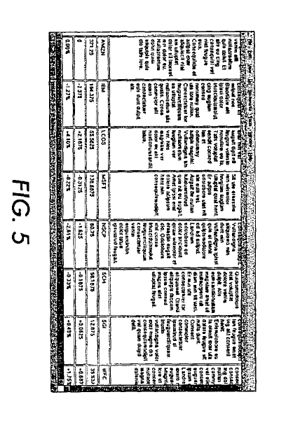

FIGS. 4 and 5 show financial information extracted from the web page of FIGS. 2-3 (as well as other unshown web pages) using the methods and systems of the invention. Of these, FIG. 4 shows the extracted data output in into a spreadsheet format and FIG. 5 shows the extracted financial data in HTML table format.

In the table shown in FIG. 4, the rows of the table correspond to different web pages, with each page representing financial information for a company as a non-limiting example. The columns of the table represent the information content of each page, such as, for example, a source/web site (col. A), a particular field, such as “Quote for (insert ticker name)” (col. B), a text field (col. C), the ticker symbol (col. D), stock price (col. E), changes in the stock price (col. F), percentage change in price (col. G), trading volume (col. H), etc. However, the “information” may take many forms and is not limited to solely financial information. That is, it may contain any type of information embedded within an HTML document, such as text, graphics, links or the like. Specific non-limiting examples of other web page or HTML document content may include various records, such as medical records, billing records, maintenance records, recipes, chat room discussions, bulletin board postings, job listings and the like. Generally, any information that can be compiled, either fixed or variable, that can be presented in similar format on different documents.

An alternative exemplary target output format is the HTML table in FIG. 5, which includes columns corresponding to different web pages (including those of FIGS. 2-3 and others), and rows corresponding to information content.

Information extraction according to the invention operates by comparing different variants containing analogous information. This may be by comparing different entities, i.e., different web pages, each with similar information and format, such as stock prices, product listings, etc. Operation may also be by comparing successive versions of a web page describing the same entity at different points in time. As a generality, the inventive methods are concerned with the differences between the pages corresponding to the information of interest (i.e., the variable information), while the constant or fixed parts correspond to structural information irrelevant for purposes of data extraction. However, certain embodiments may extract fixed data and neglect variable information or may allow a user to specify various combinations of systematic differences and similarities (fixed and variable data) to extract. For example, a user may specify exclusion from extraction of all advertisements.

The inventive comparison process is structural in that it takes advantage of the structure of the HTML format by recognizing the commonality of related pages and distinguishing data from structure. In exemplary described implementations, the HTML formatting making up the different information is parsed into a tree structure, in which each node has a potentially arbitrary number of children. Then, a function operation compares the tree structures using tree isomorphism as a comparison mechanism to isolate items of interest automatically from various HTML coded documents.

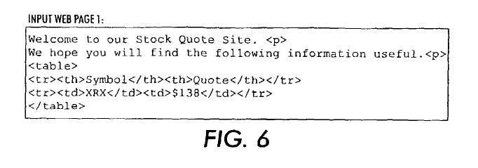

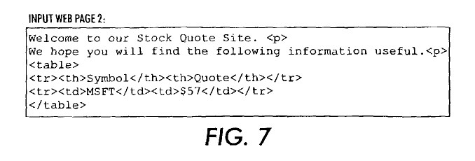

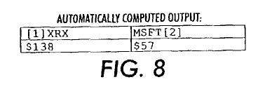

A simplest form of the inventive data extraction function/process will be described with reference to FIGS. 6-8, where FIGS. 6-7 show simplistic, first and second input web pages in HTML format and FIG. 8 shows an output table of extracted information from the web pages of FIGS. 6-7. In this example, the output table is itself formatted in HTML, but it could be in the form of a relational database as in FIG. 5 or output in spreadsheet format as shown in exemplary FIG. 4. Other suitable known or subsequently developed target output formats may be used to present the extracted data without deviating from the scope of the invention. Moreover, the extracted output need not be the entire web page, as in the FIGS. 4-5 embodiment. Rather, as in the FIG. 8 embodiment, only variable information may be extracted and output. That is, although the exemplary websites of FIGS. 6-7 have sub-pages with both duplicative content and variable content, only the variable content is extracted and output. In the FIG. 8 example, this output variable information corresponds to company ticker name and stock price. However, as apparent, the invention is not limited to such, and instead is intended to encompass extraction and output of any known or subsequently developed variable information content.

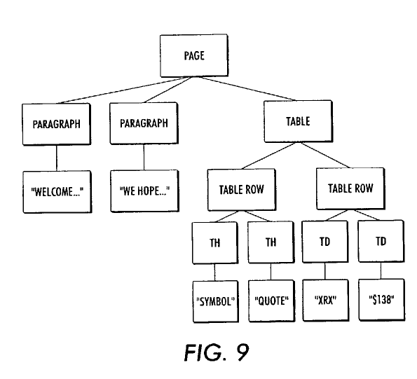

In this simple example, the tree structure is processed using the HTML formatting codes as structure. As apparent, both pages consist of an opening paragraph of text and a second paragraph of text demarcated by <p> symbols. A table is also present with the various data separated by HTML symbols. More specific details on the data extraction process will be provided with reference to FIGS. 9-11, which correspond to the input web pages of FIGS. 6-7 broken down into the hierarchical tree structure shown.

Generally, as input, the data extraction function is given a list of (sub-)trees representing the parsed HTML from the web page. The function can return one of three status codes: true indicating that the trees are equivalent; false-content; and

false-recursive, indicating that the trees differ in some way. A global 2-dimensional (2D) table may be maintained that contains output rows corresponding to the different HTML source inputs, and columns corresponding to the systematic differences that the function has identified between the pages.

When the function is given a list of trees as input, there are several possibilities. A first possibility is that all of the trees are terminal. That is, they contain textural and/or image information only. If the terminal content is equal in all the sub-trees, the function returns true. Otherwise it returns false-content and creates a new column in the 2D output table, with each row in that column being filled with the content from each of the trees.

A second possibility is that the trees are non-terminal, but are not structurally equivalent at their root nodes. For example, the root nodes may have a different number of children, or the children may have different “types” (HTML tags). In that case, the function behaves as in the previous case of unequal terminal nodes. In a strict exact isomorphism case, the process stops when the it comes across two non-terminal nodes that are not structurally equivalent. All the HTML document tree under those nodes are then considered variable content. However, it is possible to use an approximate tree isomorphism in which certain differences in correspondence are allowed and treated specially.

A third possibility is that the trees are structurally similar at their root node. That is, their root nodes contain the same number of children and the children all have the same “type” (HTML tags). Then, the function invokes itself recursively on corresponding children. If the recursive invocations all return true, the function returns true. Otherwise, it returns false-recursive .

In either the terminal or non-terminal case, correspondence may be approximate rather than exact. A general approach is this. Assume we arrive at a situation in which we find two non-terminal nodes not structurally equivalent. Rather than giving up, we can attempt to put as many of their children into correspondence as possible. This may be achieved by use of approximate tree algorithms. Such an approximation preferably depends on criteria desired or specified by the user.

Examples of user-specified criteria for approximate equivalents include.

(1) two non-terminal nodes are considered equivalent if both of them consist of a variable list of numbers.

(2) any images are considered equivalent if they come from a set of well-known servers, such as servers serving advertising.

(3) any two non-terminal nodes are considered equivalent if the only structural differences among them are related to minor stylistic markup variations, such as differing font, color, font size, bold, italics, underlining, or hyperlinking.

In another form of approximate equivalence, two nodes are considered approximately equivalent if their subnodes can be reordered and then placed in one-to-one correspondence, as previously described.

In another form of approximate equivalence, for each of the two nodes being considered for equivalence, as many subnodes as possible are attempted to be placed in correspondence. In doing this, one may either require that the order of the subnodes is preserved, or may allow limited or arbitrary reordering of the subnodes. The result of performing the equivalence is a set of subnodes that have been placed into correspondence and a set of subnodes that have not been placed into correspondence. If the set of non-equivalent subnodes is empty, then the two nodes are considered equivalent. If the set of non-equivalent subnodes is non-empty, then this set is considered a semantically meaningful difference and treated as the value of a non-equivalent terminal node.

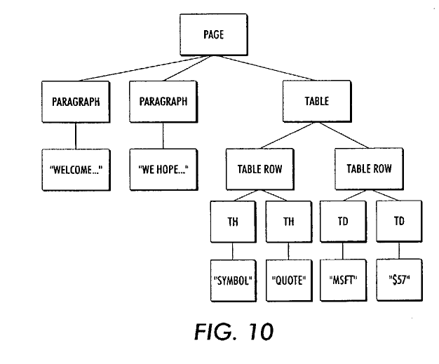

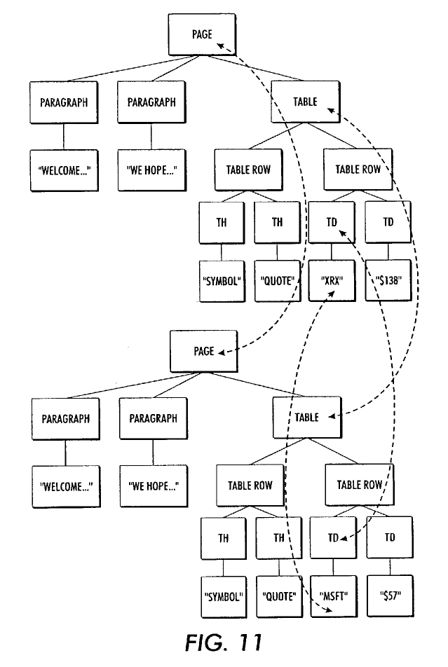

An exemplary tree isomorphism routine will be better described referring back again to the simple embodiment of FIGS. 6-8 as well as the more detailed diagrams of FIGS. 9-11. FIG. 9 shows the tree structure of the HTML web page of FIG. 6, while FIG. 10 shows the tree structure of the HTML web page of FIG. 7. FIG. 11 illustrates the comparison of tree structures.

As can be readily seen, each of the illustrative web pages of FIGS. 6-7 have the same structure. As such, each web page has the same general tree structure as shown in FIGS. 9-10. That is, each web page consists of two paragraphs and a table. The first and second paragraphs are the same in each of the FIG. 6 and FIG. 7 examples. Moreover, the tables in each example consist of a 2×2 grid of information, with the information in two of the grids being the same in both web pages and the information in the other two grids being different.

Using the inventive process, the two structures are automatically compared, as schematically illustrated in FIG. 11, to derive at the output in FIG. 8, which identifies the variable data content within the web page (shown bolded). In this example, there are the same number of sub-tree elements. Thus, this example and comparison follow the third possibility discussed above where the root nodes contain the same number of children and the children all have the same content type. Many of the sub-tree elements are identical in both web pages. However, the contents of two of the children differ. These are highlighted in bold in FIG. 11. For this example, it is this variable information that changes between web pages of the same format that is automatically extracted and output into the table shown in FIG. 8.

A more detailed exemplary tree isomorphism process according to the invention is provided in Table 1 below, which incorporates the inventive ideas of this application to take multiple HTML files/documents and output an HTML table containing different data items as rows to perform data extraction. This particular example is written in source code from a Perl5 programming language.

In the various exemplary embodiments outlined above, a system for implementing the automatic data extraction can be embodied in a programmed general purpose computer. However, the automatic data extraction system could also be implemented using a special purpose computer, a programmed microprocessor or micro controller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device capable of implementing a finite state machine that is in turn capable of implementing the processing steps outlined above can be used to implement the system.

These above examples show how methods and processes of automatic data extraction according to the invention can be used to isolate and extract various information from HTML coded documents, such as web pages, without operator intervention, by looking for structural similarities and/or dissimilarities between web pages presenting different content in the same format. However, while the extraction can proceed without operator intervention, it may be desirable to have user specified extraction criteria programmed or entered by a user prior to the extraction. This may be particularly useful when using an approximate tree isomorphism.

The methods and systems of the invention are useful for many types of HTML formatted documents or web pages. Such methods can be further refined based on the desired “content” that is to be extracted. For example, one type of text or graphic that is often changed upon each access to a web page is the advertising banners. However, such variations are often not considered by the user to be “relevant” content data. Rather, many users are annoyed with banner and pop-up advertisements, and the methods and systems may be used to detect and ignore such advertising banners. For example, even though these may be dynamic changing data, it can be treated as variations in structure and ignored. Thus, if one were to reload the same web page multiple times, the dynamically changing data would likely be advertising related data and could be ignored in the data extraction. Thus, non-website specific content such as advertisements could be effectively removed by data extraction. Conversely, if different web pages are loaded from within some related group of pages and compared using the inventive data extraction methods, textual differences are likely to be meaningful content, as in the FIGS. 5-7 example.

Additionally, the methods and systems of the invention may be used to recognize minor stylistic markup of data, such as italics, bold face, hyperlinks, etc. These minor variations may be treated as variations in textual content rather than variations in structure.

Furthermore, the methods and systems of the invention may be expanded to also perform matching of text strings to remove common phrases. This may help to reduce the amount of extracted information down to a desired level. For example, the phrase “The stock price is 5¼” vs. “The stock price is 6 ⅝” would result in the outputs “5¼” and “6⅝ ”. Such further matching can be accomplished by computing strings with minimal edit distance. While this is a somewhat different method, more closely related to known prior art “wrapper induction” methods of extraction, it nonetheless may be incorporated or integrated into the inventive process to achieve higher levels of data extraction within textual fields.

While the systems and methods of this invention have been described in conjunction with the specific embodiments outlined above, it is evident that many alternatives, modifications and variations will be apparent to those skilled in the art. Accordingly, the exemplary embodiments of the systems and methods of this invention, as set forth above, are intended to be illustrative, not limiting. Various changes may be made without departing from the spirit and scope of the invention. For example, while exemplary embodiments use a recursive tree isomorphism algorithm, similar results can be achieved if more complex techniques are used, such as a non-recursive iterative algorithm using a stack or queue data structure. Alternatively, a relation-style or simulated annealing style algorithm may be used for the tree isomorphism. Additionally, tree isomorphism can be implemented by encoding the trees as graphs and applying a graph isomorphism algorithm.

Additionally, although the tree isomorphism is preferably exact, similar results may be obtained if the isomorphism is only approximate

TABLE 1
# usage: compare file1.html file2.html file3.html
use strict;
use strict ‘refs’;
use HTML::TreeBuilder;
sub printhtml {

my ($r,$indent) = @_;
if(ref $r) {

print “.” x $indent;
print $r->tag( ),“\n”;
my $content = $r->content( );
if($content) {

foreach my $e (@{$content}) {

printhtml ($e,$indent+3);

}

}

} else {

my $t = $r;
$t =− s/\s*//;
$t =− s/\s*$//;
my $n = 60 − $indent;
if($t ne “”) {

print “ ” x $indent;
print ‘”’,substr($t,0,$n);
print “...” if length $t>=$n;
print ‘”’, “\n”;

}

}

}
sub abbrev {

my ($t) = @_;
my $result = “”;
if(ref $t) {

if(ref($t) ne “ARRAY”) {

$result .= substr($t->as_HTML( ),0,20);

} else {

$result .= $t;

}

} else {

$result .= $t;

}
$result =− s/\n/\\n/msgi;
return $result;

}
sub alleq {

# print “>>> alleq ”, (join “ ”,@_),“\n”;
for(my $i=1;$i<@_;$i++) { return 0 if $_[$i] ne $_[0]; }
return 1;

}
sub every (&@) {

my $f = shift;
foreach $_{—} (@_) { return 0 unless &$f; }
return 1;

}
sub p (@) { print join “ ”,@_,“\n”; }
sub is_html_element {

my ($e) = @_;
return (ref($e) eq “HTML::TreeBuilder” ∥ ref($e) eq “HTML::
Element”);

}
# my @test = (1,2,3,4,5); print every { $_{—} < 5 } @test; print “\n”; exit 0;
# my @test = qw(a b a a); print (alleq @test),“\n”; exit 0;
sub htmlequiv {

my ($trees,$result) = @_;
my $failed = undef;
if(ref($trees) ne “ARRAY”) {

die “$trees: not an array reference”;

}
if(every {!ref($_)} @$trees) {

$failed = “unequal content” unless alleq @$trees;

} elsif(every {is_html_element($_)} @$trees) {

if(!alleq(map {ref($_->content( ))} @$trees)) {

$failed = “unequal content types”;

} elsif(!alleq(map {length $_->content( )} @$trees)) {

$failed = “unequal content lengths”;

} elsif(every {is_html_element(ref $_->
content( ))} @$trees) {

$failed = “recursive” unless htmlequiv(map {$_->
content( )}@$trees);

} elsif(!every {ref $_->content( ) eq “ARRAY”} @$trees) {

p map {“”.ref($_->content( ))} @$trees;

} else {

my $n = length $trees->[0]->content( );
for(my $i=0;$i<$n;$i++) {

my @sub = map { $_->content( )->[$i] } @$trees;
$failed = “recursive” unless htmlequiv(\@sub,$result);

}

}

} else {

$failed = “unequal types (top)”;

}
if($failed && $failed ne “recursive”) {

push @{$result},$trees;
print STDERR “>>> failed = $failed\n”;
print STDERR (join “ ”,@$trees),“\n”;
print STDERR “ ”;
foreach my $t (@$trees) { print STDERR ‘ “’,abbrev($t). ‘”’; }
print STDERR “\n”;

}
return !$failed;

}
my @trees;
for(my $i=0;$i<@ARGV;$i++) {

print STDERR $ARGV[$i],“\n”;
$trees[$i] = new HTML::TreeBuilder;
$trees[$i]->parse_file($ARGV[$i]);

}
my @equivs;
htmlequiv \@trees,\@equivs;
print “<table border=1 cellpadding=5>\n”;
foreach my $equiv (@eqnivs) {

print “\n<1-- ----------------------------------------------- -->\n\n”;
print “<tr>\n\n”;
foreach my $col (@{$equiv}) {

print “<td>\n”;
my $content = (ref $col)?$col->as_HTML( ):$col;
$content =− s|<td,*?>∥msgi;
$content =− s|</td.*?>∥msgi;
$content =− s|<tr.*?>∥msgi;
$content =− s|</tr.*?>∥msgi;
print $content;
print “\n”;
print “</td>\n”;

}
print “\n</tr>\n”;

}
print “</table>\n”;
# Local Variables:
# mode:perl
# end:

1. A method of automatic data extraction from a plurality of html formatted documents, comprising:
parsing each of several HTML formatted input documents into a tree structure having at least one root node and a sub-tree containing information data;
performing a tree isomorphism function operation on each input document tree structure to compare the tree structures;
based on specified criteria, extracting at least a subset of systematic differences and/or similarities obtained from a systematic comparison of information data contained within corresponding sub-trees; and
outputting extracted data in a desired target output format.

2. The method of automatic data extraction of claim 1, wherein the systematic comparison identifies and outputs only systematic differences in information data contained within corresponding sub-trees of the various several HTML formatted input documents.

3. The method of automatic data extraction of claim 1, wherein the systematic comparison identifies and excludes from output systematic differences in information data.

4. The method of automatic data extraction of claim 3, wherein at least two of the several HTML formatted input documents are obtained from a same input source, but obtained at different times.

5. The method of automatic data extraction of claim 1, wherein the desired target output format is in the form of a relational database.

6. The method of automatic data extraction of claim 1, wherein the desired target output format is in the form of a spreadsheet.

7. The method of automatic data extraction of claim 1, wherein the desired target output format is in the form of a two-dimensional table.

8. The method of automatic data extraction of claim 1, wherein the tree isomorphism operation performs a recursive function operation on the tree structure.

9. The method of automatic data extraction of claim 8, wherein the step of performing a recursive function operation returns a true value when all of the trees are terminal and the information data of each sub-tree of a first tree is equal to information data of each sub-tree of a second tree.

10. The method of automatic data extraction of claim 9, wherein the desired target output format is a two-dimensional output table of rows and columns and the step of performing a recursive function operation returns a false-content value and creates a new column in the two-dimensional output table when the information data of any sub-tree of the first tree does not equal the information data of a corresponding sub-tree of the second tree.

11. The method of automatic data extraction of claim 8, wherein the desired target output format is a two-dimensional output table of rows and columns and the step of performing a recursive function operation returns a false-content value and creates a new column in the two-dimensional output table when a root node of a first tree differs in one of number of children or information type from the corresponding root node of a second tree.

12. The method of automatic data extraction of claim 8, wherein when the step of performing a recursive function operation determines that the root node of a first tree is structurally similar to a root node of a second tree by having a same number of children and information data type, the function is invoked recursively on corresponding children.

13. The method of automatic data extraction of claim 12, wherein if the recursive functions of each of the children return true, an overall function returns true .

14. The method of automatic data extraction of claim 1, wherein the tree isomorphism function is an approximation.

15. The method of automatic data extraction of claim 14, wherein user specified criteria selects the level of approximation.

16. The method of automatic data extraction of claim 15, wherein minor differences in stylistic markup of information data are ignored and set as an acceptable level of approximation.

17. A method of automatic data extraction from a plurality of HTML formatted documents, comprising:
parsing each of several HTML formatted input documents into a tree structure having at least one root node and a sub-tree;
performing a tree isomorphism function operation on each tree structure to compare the tree structures;
based on specified criteria, extracting at least a subset of systematic differences and/or similarities obtained from a systematic comparison of information data contained within corresponding sub-trees; and
outputting extracted data in a desired target output format.

18. The method of automatic data extraction of claim 17, wherein the desired target output format is in the form of a relational database.

19. The method of automatic data extraction of claim 17, wherein the desired target output format is in the form of a spreadsheet.

20. The method of automatic data extraction of claim 17, wherein the desired target output format is in the form of a two-dimensional table.

21. The method of automatic data extraction of claim 17, wherein the tree isomorphism operation performs a recursive function operation on the tree structure.

22. The method of automatic data extraction of claim 17, wherein the step of performing a recursive function operation returns a true value when all of the trees are terminal and the information data of each sub-tree of a first tree is equal to information data of each sub-tree of a second tree.

23. The method of automatic data extraction of claim 22, wherein the desired target output format is a two-dimensional output table of rows and columns and the step of performing a recursive function operation returns a false-content value and creates a new column in the two-dimensional output table when the information data of any sub-tree of the first tree does not equal the information data of a corresponding sub-tree of the second tree.

24. The method of automatic data extraction of claim 23, wherein the desired target output format is a two-dimensional output table of rows and columns and the step of performing a recursive function operation returns a false-content value and creates a new column in the two-dimensional output table when a root node of a first tree differs in one of number of children or information type from the corresponding root node of a second tree.

25. The method of automatic data extraction of claim 23, wherein the desired target output format is a two-dimensional output table of rows and columns and the step of performing a recursive function operation returns a false-content value and creates a new column in the two-dimensional output table when a root node of a first tree differs in one of number of children or information type from the corresponding root node of a second tree.

26. The method of automatic data extraction of claim 25, wherein if the recursive functions of each of the children return true, an overall function returns true .

27. The method of automatic data extraction of claim 17, wherein constant components that do not change among the various HTML formatted documents are considered structure.

28. The method of automatic data extraction of claim 17, wherein the tree isomorphism function operation is an approximation.

29. The method of automatic data extraction of claim 28, wherein user specified criteria selects the level of approximation.

30. The method of automatic data extraction of claim 29, wherein minor differences in stylistic markup of information data are ignored and set as an acceptable level of approximation.
